(19) United States
(12) Patent Application Publication
(10) Pub. No.: US 2026/0087293 A1
(43) Pub. Date: Mar. 26, 2026

(54) AUTHENTICATION APPARATUS, AUTHENTICATION APPARATUS ARRANGEMENT, AND AUTHENTICATION DEVICE

(71) Applicant: Infineon Technologies AG, Neubiberg (DE)

(72) Inventor: Walter Hartner, Bad Abbach (DE)

(21) Appl. No.: 19/339,441

(22) Filed: Sep. 25, 2025

(30) Foreign Application Priority Data
Sep. 25, 2024 (DE) 102024209232.0

(51) Int. Cl. G06K 19/067; G06K 19/06

(52) U.S. Cl. CPC G06K 19/0672; G06K 19/06131

(57) ABSTRACT

An authentication apparatus is provided. The authentication apparatus has a dielectric carrier and a plurality of millimeter wave resonance structures on or in the dielectric carrier, wherein at least one first millimeter wave resonance structure of the millimeter wave resonance structures has a first resonant frequency, which has a first resonance strength when irradiated at the first resonant frequency, and wherein at least one second millimeter wave resonance structure of the millimeter wave resonance structures has a second resonant frequency, which has a second resonance strength, which is equal to the first resonance strength or is different from it, when irradiated at the second resonant frequency.

### REFERENCE TO RELATED APPLICATION

This Application claims priority to German Application number 102024209232.0, filed on September 25, 2024, the contents of which are hereby incorporated by reference in their entirety.

### TECHNICAL FIELD

The present disclosure relates to an authentication apparatus, an authentication apparatus arrangement, an authentication device, and an authentication system.

### BACKGROUND

There are many applications in which authentication of original branded products is desired, for example authentication of original cigarettes against a base device of an e-cigarette or authentication of medical cartridges, possibly together with detection of the correct cartridge placement.

A flexible solution can be desired for the system. Such a flexible solution can provide, for example, for the use of a passive authentication apparatus rather than an active authentication apparatus, which would enable a cost-effective solution.

Furthermore, it may be desirable to use an authentication apparatus without cables, which could cause contacts not to come into contact with liquids, for example. In addition, it may also be desirable to be able to perform the authentication through material, thus ruling out optical materials.

### BRIEF DESCRIPTION

An authentication apparatus is provided. The authentication apparatus has a dielectric carrier and a plurality of millimeter wave resonance structures on or in the dielectric carrier, wherein at least one first millimeter wave resonance structure of the millimeter wave resonance structures has a first resonant frequency, which has a first resonance strength when irradiated at the first resonant frequency, and wherein at least one second millimeter wave resonance structure of the millimeter wave resonance structures has a second resonant frequency, which has a second resonance strength, which is equal to the first resonance strength or is different from it, when irradiated at the second resonant frequency.

An authentication apparatus arrangement is provided. The authentication apparatus arrangement has an authentication object and an authentication apparatus according to one of the exemplary embodiments, wherein the authentication apparatus is fixed to the authentication object.

An authentication device is provided. The authentication device has at least one transceiver which is configured to send and receive millimeter waves, wherein the at least one transceiver has a plurality of antennas, wherein at least one first antenna of the plurality of antennas is configured to send and receive millimeter waves of a first frequency, and wherein at least one second antenna of the plurality of antennas is configured to send and receive millimeter waves of a second frequency, and a processor which is configured to: initiate sending of millimeter waves of the first frequency to an authentication apparatus, capture a first resonance strength with respect to the first frequency of millimeter wave resonance structures in the authentication apparatus, assign a first code value to the captured first resonance strength, cause sending of millimeter waves of the second frequency to the authentication apparatus, capture a second resonance strength with respect to the second frequency of millimeter wave resonance structures in the authentication apparatus, assign a second code value to the captured second resonance strength, form a code word that has the first code value and the second code value.

An authentication system is provided. The authentication system comprises an authentication apparatus according to one exemplary embodiment or an authentication apparatus arrangement according to one exemplary embodiment, and an authentication device according to one exemplary embodiment, wherein the first frequency, for the emission of which the first antenna is configured, is equal to the first resonant frequency, and wherein the second frequency, for the emission of which the second antenna is configured, is equal to the second resonant frequency.

An authentication method is provided. The authentication method comprises initiating sending of millimeter waves of the first frequency to an authentication apparatus, capturing a first resonance strength with respect to the first frequency of millimeter wave resonance structures in the authentication apparatus, assigning a first code value to the captured first resonance strength, initiating sending of millimeter waves of the second frequency to the authentication apparatus, capturing a second resonance strength with respect to the second frequency of millimeter wave resonance structures in the authentication apparatus, assigning a second code value to the captured second resonance strength, and forming a code word that has the first code value and the second code value.

### BRIEF DESCRIPTION OF THE DRAWINGS

The present disclosure is shown in an exemplary and non-limiting manner in the illustrations of the attached drawings, in which identical reference numbers refer to similar or identical elements. The elements in the drawings are not necessarily depicted to scale in relation to each other. The features of the various examples shown can be combined, provided that they are not mutually exclusive.

FIG. 1 shows a schematic representation of an authentication apparatus according to various exemplary embodiments.

FIGS. 2A to 2D each show a schematic representation of an authentication device according to various exemplary embodiments.

FIG. 3 shows a schematic representation which illustrates aspects of the authentication apparatus and the authentication device according to various exemplary embodiments.

FIG. 4 shows a schematic representation of an authentication system according to various exemplary embodiments and schematically illustrates its use.

FIGS. 5A to 5D each illustrate an authentication system according to various exemplary embodiments and illustrate its use.

FIG. 6 illustrates properties of millimeter wave antennas and millimeter wave resonance structures in relation to their use in various exemplary embodiments.

FIG. 7 shows a schematic illustration of different antenna shapes and resonance structures matched thereto (or vice versa).

FIG. 8 shows a flowchart of an authentication method according to various exemplary embodiments.

### DETAILED DESCRIPTION

An authentication and coding concept is provided, which, by using millimeter wave signals, is suitable for generating an identifier or authentication (ID) which can be retrieved or read passively, without contact, and passing through material.

In various exemplary embodiments, a coding can be generated by means of an authentication apparatus by way of different meta-structures, each having a specific resonant frequency. For each frequency at which millimeter waves can be sent to the authentication apparatus, the different meta-structures can generate a signal that has one of multiple different intensity levels for the specific meta-structure depending on the number and structure of the respective meta-structures. The different intensity levels for the specific meta-structure can be used to code different numbers. In addition, the different frequencies can be used to determine the sequence of numbers.

Different designs of the antennas, for example in terms of size and/or shape, may be matched in different exemplary embodiments to designs of the meta-structures.

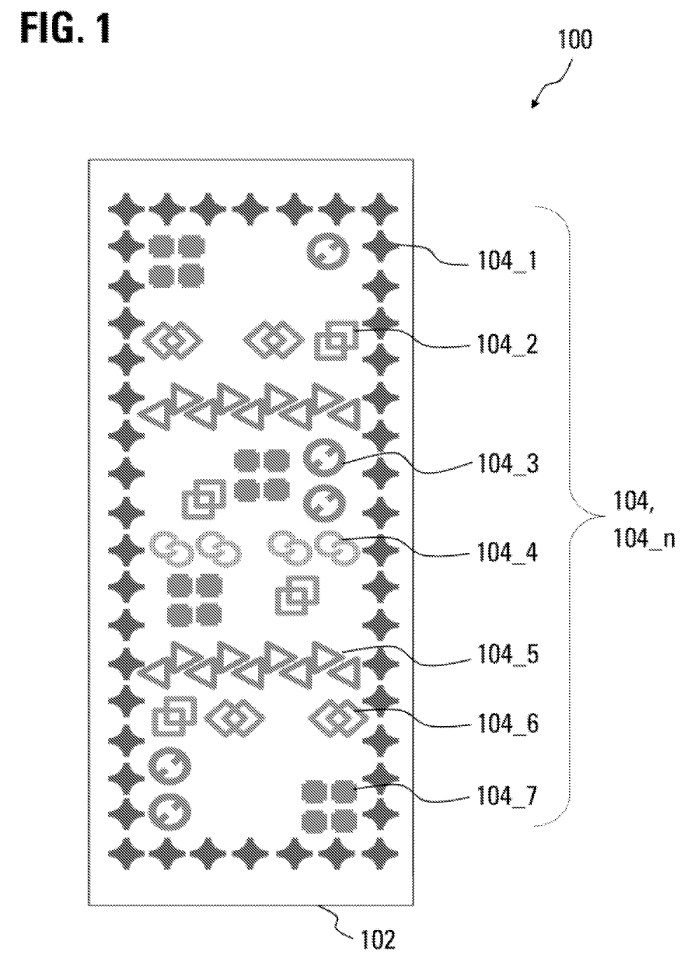

FIG. 1 shows a schematic representation of an authentication apparatus 100 according to various exemplary embodiments.

The authentication apparatus 100 has in various exemplary embodiments a dielectric carrier 102 and a plurality of millimeter wave resonance structures 104 (these are also referred to herein as meta-structures) on or in the dielectric carrier 102. The dielectric carrier 102 may have, for example, a dielectric material such as a plastic material, e.g. a polymer, for example polypropylene, or a resin, a glass or ceramic material, a wood material, a fabric made of dielectric fibers, or another suitable material, wherein any dielectric material that makes it possible to arrange the millimeter wave resonance structures 104 on or in the dielectric carrier 102 in such a way that the individual millimeter wave resonance structures 104 are connected to the dielectric carrier 102 and are mutually electrically insulated from each other by the dielectric carrier 102 may be suitable.

In various exemplary embodiments, the dielectric carrier 102 may be part of a (e.g. multi-layer) carrier structure, wherein the carrier structure may have electrically conductive components, for example layers, provided that it is ensured that the millimeter wave resonance structures 104 are electrically insulated from the electrically conductive components, for example by means of the dielectric carrier 102.

In various exemplary embodiments, the millimeter wave resonance structures 104 may be embedded in the dielectric carrier 102 or, for example, may be covered by an additional dielectric material, for example, by a top layer and/or protective layer, for example in order to hide a presence and/or a position of the authentication apparatus 100 and/or the millimeter wave resonance structures 104. In various exemplary embodiments, the millimeter wave resonance structures 104 on the dielectric carrier 102 and possibly the dielectric carrier 102 itself can be exposed.

The millimeter wave resonance structures 104 may comprise or consist of an electrically conductive material, for example aluminum, copper, silver, or any other suitable metal, or, for example, a conductive carbon such as graphite.

In various exemplary embodiments, at least one first millimeter wave resonance structure 104_1 of the millimeter wave resonance structures 104 has a first resonant frequency, which has a first resonance strength when irradiated at the first resonant frequency, and at least one second millimeter wave resonance structure 104_2 of the millimeter wave resonance structures has a second resonant frequency, which has a second resonance strength, which is equal to the first resonance strength or is different from it, when irradiated at the second resonant frequency.

The plurality of millimeter wave resonance structures 104 may further comprise one or more further millimeter wave resonance structures 104_3, 104_4, and so on, each having a further resonant frequency, which has/have a further resonance strength when irradiated at the further resonant frequency.

The exemplary embodiment illustrated in FIG. 1 shows an authentication apparatus 100 having by way of example seven different millimeter wave resonance structures 104 or groups of millimeter wave resonance structures 104, namely the first (group of) millimeter wave resonance structures 104_1, the second (group of) millimeter wave resonance structures 104_2, and the further (groups of) (group of) millimeter wave resonance structures 104_3 to 104_7.

Since the plurality of millimeter wave resonance structures 104 may have both a plurality of millimeter wave resonance structures 104 which are structurally similar to each other (for example, the millimeter wave resonance structures 104_1, the millimeter wave resonance structures 104_2, etc.) and millimeter wave resonance structures 104 which differ structurally from each other (104_1 compared to 104_2 to 104_7, etc.), a plurality of structurally similar millimeter wave resonance structures 104 will be referred to herein in relationships, where this facilitates understanding, as "group of millimeter wave resonance structures 104" or "group of millimeter wave resonance structures 104_n".

In other words, all individual millimeter wave resonance structures 104 in a group of millimeter wave resonance structures 104_n have the same structure, whereas millimeter wave resonance structures 104 in different groups of millimeter wave resonance structures 104_n differ structurally from each other. In particular, the at least one first of the millimeter wave resonance structures 104_1 differs structurally from the at least one second of the millimeter wave resonance structures 104_2 and the other millimeter wave resonance structures 104_3 to 104_7, the second of the millimeter wave resonance structures 104_2 differs structurally from each of the other millimeter wave resonance structures 104_2 and 104_3 to 104_7, etc.

In various exemplary embodiments, a structural difference between the millimeter wave resonance structures 104 may mean that, for example, each of the at least one first of the millimeter wave resonance structures 104_1 has a different size and/or a different shape than the at least one second of the millimeter wave resonance structures 104_2. This applies mutatis mutandis to the structural differences between all groups of millimeter wave resonance structures 104_1, 104_2, …, 104_7 which should only be understood as examples of the respective number and shape of the plurality of millimeter wave resonance structures 104.

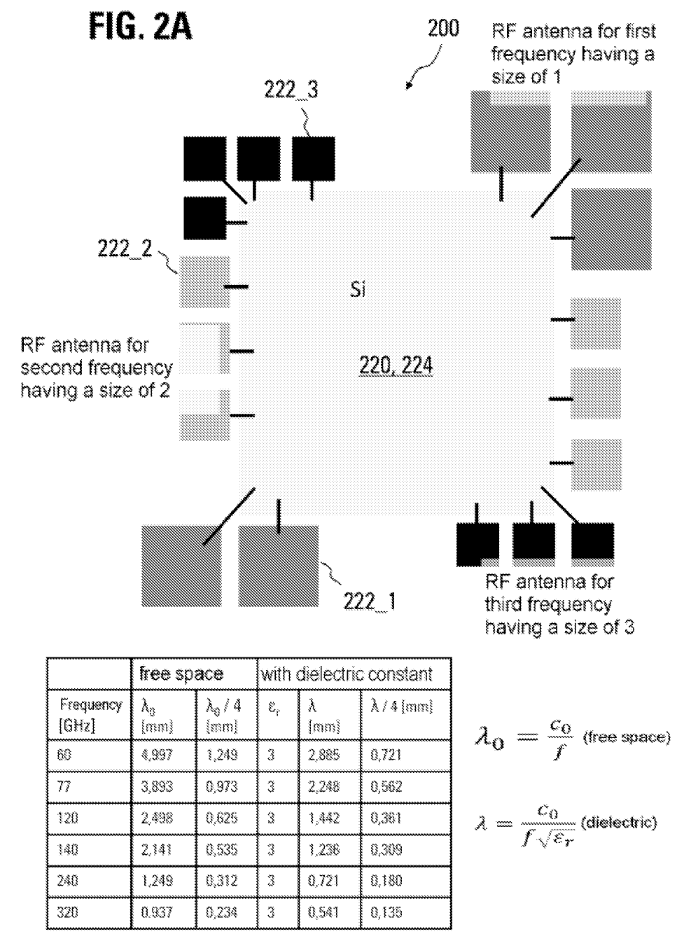

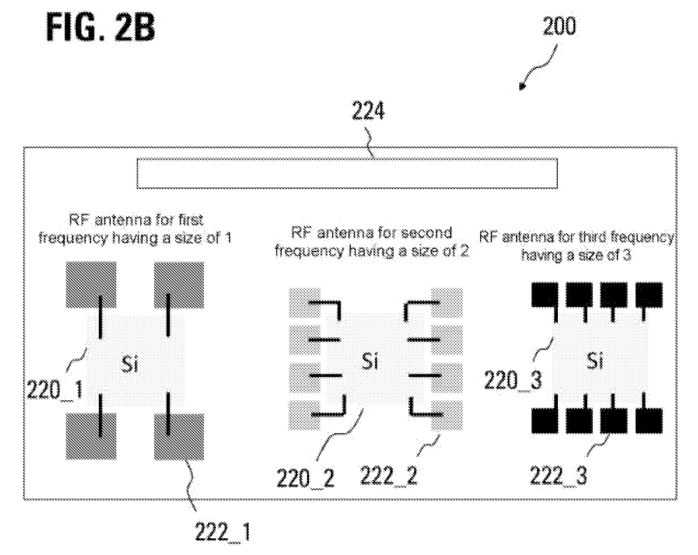

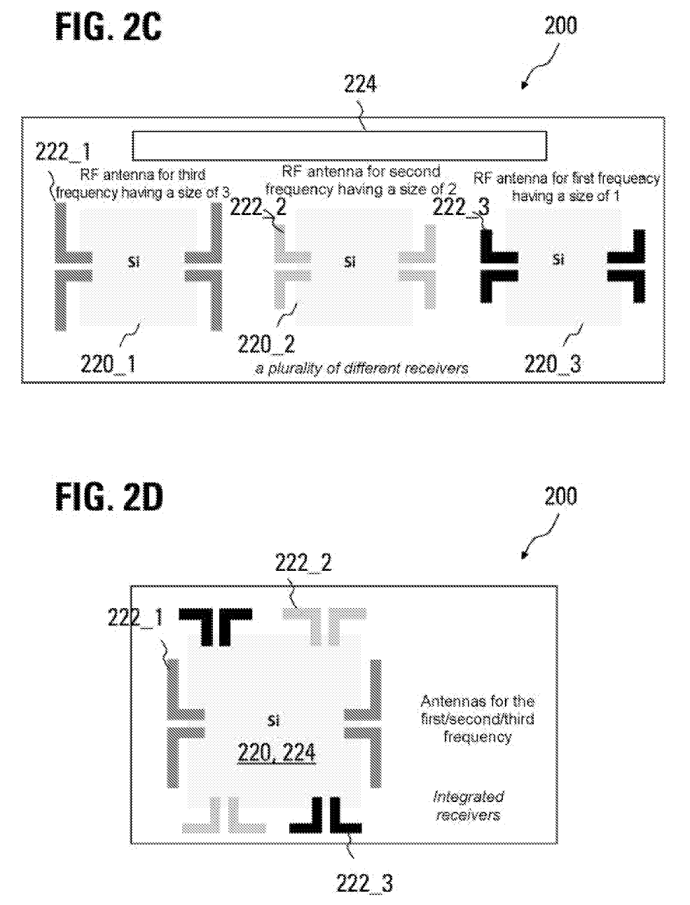

Although the shapes shown in FIG. 1 should essentially be understood as being symbolic of the number of millimeter wave resonance structures 104 in each of the groups of millimeter wave resonance structures 104_n and their relative size and shape, some aspects of the design and/or arrangement of the millimeter wave resonance structures 104 are shown by way of example in FIG. 1. For example, a number of millimeter wave resonance structures 104 in a group of millimeter wave resonance structures 104_n can vary between 1 and a substantially arbitrary higher number (for example, more than 40 millimeter wave resonance structures 104_1, but only four millimeter wave resonance structures 104_7). An arrangement of the millimeter wave resonance structures 104 on the dielectric carrier 102 may be structured in an ordered manner (such as the arrangement of the millimeter wave resonance structures 104_1 in a rectangular shape or the double-linear arrangement of the millimeter wave resonance structures 104_5) or seemingly unordered and random (such as the arrangement of the millimeter wave resonance structures 104_2 and/or 104_3). For example, a shape of each of the millimeter wave resonance structures 104 may be contiguous and extensive (as in the millimeter wave resonance structures 104_1), extensive with interruptions (as in the millimeter wave resonance structures 104_7), formed from a single contiguous line structure (as in the millimeter wave resonance structures 104_3), formed from a plurality of contiguous (millimeter wave resonance structures 104_6, 104_2) or separated (104_5) line structures, or other structures suitable as a resonance structure for millimeter waves of the desired frequency may be formed. A size of the millimeter wave resonance structures 104 can be different. In the example from FIG. 1, for example, an area covered by each of the millimeter wave resonance structures 104_7 is, for example, almost four times as large as that of the millimeter wave resonance structures 104_1; the extents in the horizontal and/or vertical direction each differ approximately by a factor of two, in which case the size differences should be understood as exemplary. FIG. 2A contains tables that list exemplary frequencies of millimeter waves that are possible as resonant frequencies for millimeter wave resonance structures 104 and associated values for λ/4 of the respective frequency. Dimensions of the millimeter wave resonance structures 104 may be set up such that they are tuned to λ/4 of the desired resonant frequency or a multiple thereof. As described below, this also applies to antennas for measuring the resonance strength.

In general, the plurality of millimeter wave resonance structures 104 may have, for example, shapes formed from linear shapes, polygon shapes, circular or elliptical shapes, broken linear, polygon, circular or elliptical shapes and superimpositions of two or more of the above-mentioned shapes.

A respective size and shape of the millimeter wave resonance structures 104 can be combined substantially independently of each other, for example in accordance with an antenna shape and size of that antenna which has emitted the millimeter waves at the resonant frequency and/or is provided for receiving the millimeter waves emitted by the millimeter wave resonance structures 104.

In various exemplary embodiments, the structural differences between the groups of millimeter wave resonance structures 104_n may be such that the millimeter wave resonance structures 104 in a respective group of millimeter wave resonance structures 104_n each exhibit a resonance only for the respective resonant frequency provided for the group, and no resonance with the resonant frequencies of the respective other groups of millimeter wave resonance structures 104_n.

Described clearly for the first of the millimeter wave resonance structures 104_1 and the second of the millimeter wave resonance structures 104_2, this means that the first of the millimeter wave resonance structures 104_1 has no or substantially no resonance with millimeter waves of the second resonant frequency, and the at least one second of the millimeter wave resonance structures 104_2 has no or substantially no resonance with millimeter waves of the first resonant frequency, and that this also applies mutatis mutandis to the other groups of millimeter wave resonance structures 104_n among themselves. In general, the first resonant frequency and/or the second resonant frequency (and/or further resonant frequencies of the further millimeter wave resonance structures 104) may be, for example, in a range between 24 and 320 GHz.

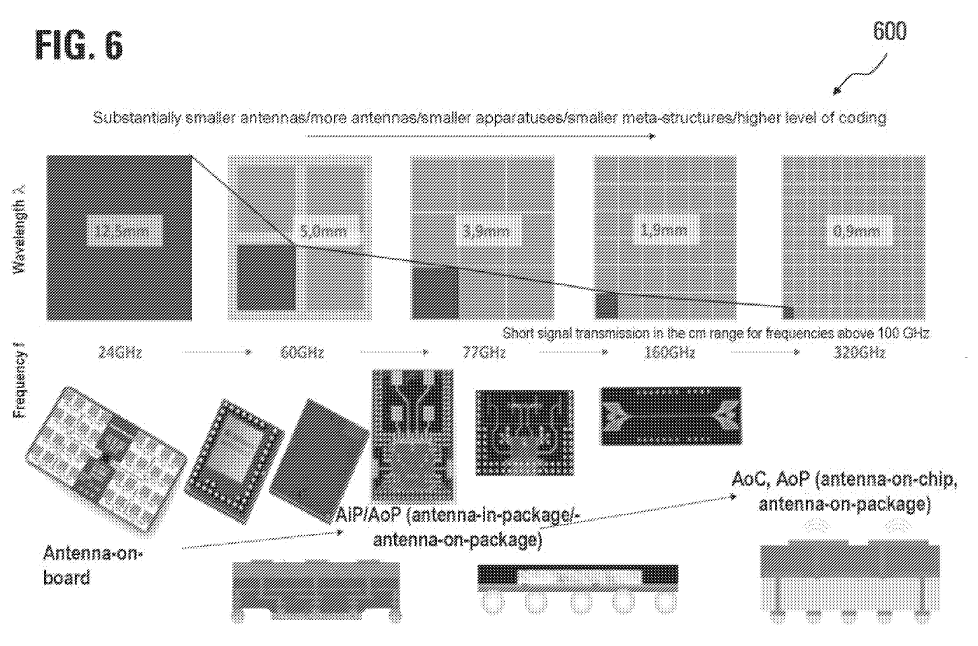

FIG. 6 illustrates how the respective frequency affects structure sizes and their use for this frequency range. This relates both to the millimeter wave resonance structures 104 in the authentication apparatus 100 and to antenna structures in authentication devices 200, which are described below.

For example, higher frequencies (within the above-mentioned range, e.g. above 100 GHz) can allow substantially smaller antennas, more antennas, smaller apparatuses, smaller meta-structures and/or a higher level of coding. The smaller antennas can make it possible, for example, for the antennas to be provided on/in a chip (as an antenna-on-chip, AoC), instead of, for example, being integrated only within a chip package (as an antenna-on-package or antenna-in-package, AoP or AiP).

FIGS. 2A to 2D each show a schematic representation of an authentication device 200 according to various exemplary embodiments.

The authentication device 200 is provided for the purpose of being used to authenticate the authentication apparatus 100, in particular for irradiating the authentication apparatus 100 with millimeter waves of a first frequency, which corresponds, for example, to the first resonant frequency, with millimeter waves of a second frequency, which corresponds, for example, to the second resonant frequency, and/or with millimeter waves of additional frequencies, which can correspond, for example, to the further resonant frequencies or cannot correspond to resonant frequencies of millimeter wave resonance structures 104 present in the authentication apparatus 100.

The authentication device 200 has at least one transceiver 220 which is configured to send and receive millimeter waves, wherein the at least one transceiver 220 has a plurality of antennas 222.

With regard to a basic send and receive functionality, the at least one transceiver 220 may be formed substantially as known from the prior art. Aspects of the exemplary embodiments can essentially relate to a selection of the emitted/received frequencies of the millimeter waves (possibly with a decidedly selected shape of the respective antenna(s)) and further processing of the (resonance) signals received by the authentication device 100, as will be explained in detail below.

In various exemplary embodiments, at least one first antenna 222_1 of the plurality of antennas 222 is configured to send and receive millimeter waves of a first frequency, and at least one second antenna 222_2 of the plurality of antennas 222 is configured to send and receive millimeter waves of a second frequency. In this case, the second frequency is different from the first frequency.

The plurality of antennas 222 may further comprise one or more further antennas 222_3, 222_4, and so on configured to send and receive millimeter waves of a further (e.g. third, fourth, etc.) frequency which is different from the first and the second frequency.

The at least one first antenna 222_1 can differ structurally from the at least one second antenna 222_2, and the first antenna 222_1 and the second antenna 222_2 can each possibly differ structurally from each of the further antennas 222_3, 222_4, and so on.

A structural distinction may refer to the fact that the at least one first antenna 222_1 has a different size and/or a different shape than the at least one second antenna 222_2 (and possibly than each of the at least one further antenna 222_3, 222_4, and so on.

The exemplary embodiments shown in FIGS. 2A to 2D illustrate that antennas 222 which are configured to receive (and, if necessary, send) millimeter waves at different frequencies have different sizes (e.g. in terms of their dimensions in a first direction and a direction orthogonal thereto, for example referred to as horizontal and vertical or X-direction and Y-direction, and/or with respect to a covered area). In particular, higher frequencies allow smaller dimensions of the antenna structures, as has already been explained above, for example, in connection with the microwave resonance structures 104 in relation to FIG. 2A and FIG. 6.

The authentication device 200 may have, as part of the at least one transceiver 220, millimeter wave/RF components or regions on a chip, for example a separate millimeter wave/RF component or a separate region for each transceiver 220_1, 220_2, 220_3, etc. Each of the millimeter wave/RF components may have its own operating frequency, which may be different, for example, from each other and may be different from the operating frequency of a processor 224, which may also be part of the chip and is explained in more detail below.

The operating frequencies of the millimeter wave/RF components can each be set up such that they match the associated transceivers 220_1, 220_2, 220_3, and so on the associated antennas 222_1, 222_2, 222_3, and so on, and the associated millimeter wave resonance structures. In particular, the plurality of millimeter wave resonance structures may have structure sizes in a range of multiples of λ/4, where λ is the wavelength of the associated operating frequency of the millimeter wave/RF component or region of the RF chip of the authentication device 200 emitting the millimeter waves.

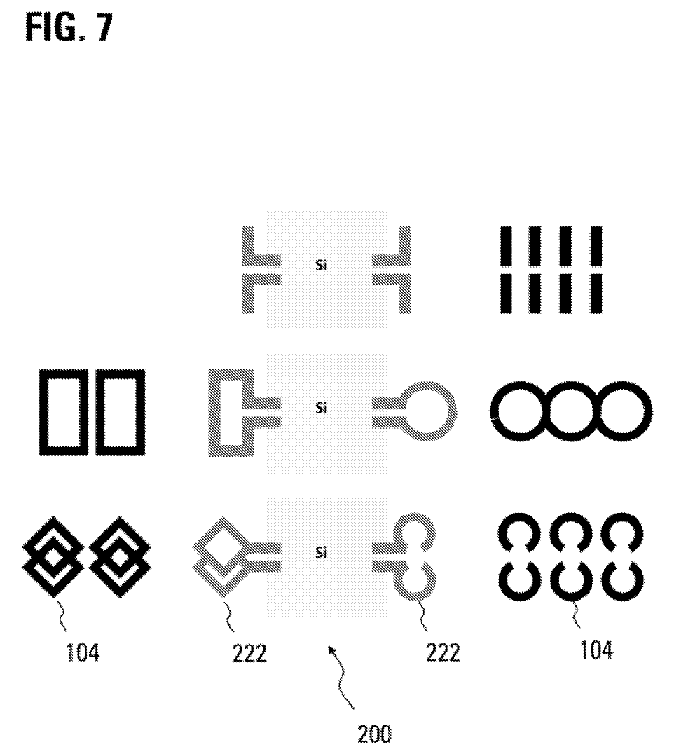

Different shapes of the antennas 222 are illustrated by way of example in FIG. 7, for example, in addition to a double linear structure which was also already shown in FIGS. 2C and 2D, a circular, rectangular, double-rhombic, or double-partial-circle structure.

In various exemplary embodiments, a respective size and shape of the antennas 222 can be arbitrarily combined, for example in accordance with the shape and/or size of the millimeter wave resonance structures 104 which are intended to resonate with the emitted frequency.

All antennas 222 can be part of a single transceiver 220, as shown by way of example in FIG. 2A and FIG. 2D, can be distributed among a plurality of individual transceivers 220, as shown by way of example in FIG. 2B and FIG. 2C, or, as a combination thereof, i.e. with a plurality of antennas 222_1, 222_2, 222_3, and so on, distributed among a plurality of transceivers 220_1, 220_2, etc.

The authentication device 200 also has the processor 224. The processor 224 may be present as a single apparatus, e.g. a microprocessor, a CPU, etc., as a processor (or a plurality of integrated processors) integrated in a chip (for example together with the antennas 222 which are designed as AoC structures), as processor(s) integrated in a package, as a single processor 224 that controls or performs all of the following functions, or as a plurality of (sub)processors 224 that, for example, perform various ones of the functions, such as a (sub)processor for an antenna driver circuit for sending and receiving the millimeter waves and an additional (sub)processor for processing the determined resonance strengths in order to form a code word (as described below), a security controller for storing reference code words for comparison with the formed code word, etc.

The processor 224 may be configured in various exemplary embodiments either to completely process the captured resonance strengths, or, for example, to only partially process the captured resonance strengths and to further process the partially processed data in a further, for example external and/or more powerful, microcontroller.

The (at least one) processor 224 is configured to initiate sending of millimeter waves of the first frequency to an authentication apparatus 100, wherein the transceivers 220 with the chip regions described above and the associated (for example electrically conductively connected) antennas 222 may be provided for actually generating the millimeter waves.

Basic functions of generating and receiving millimeter waves can be essentially set up as known in the prior art.

The processor 224 may also be configured to capture a first resonance strength with respect to the first frequency of millimeter wave resonance structures 104, 104_1 in the authentication apparatus 100, to assign a first code value to the captured first resonance strength, to initiate sending of millimeter waves of the second frequency to the authentication apparatus 100, to capture a second resonance strength with respect to the second frequency of millimeter wave resonance structures 104, 104_2 in the authentication apparatus 100, to assign a second code value to the captured second resonance strength, and to form a code word that has the first code value and the second code value.

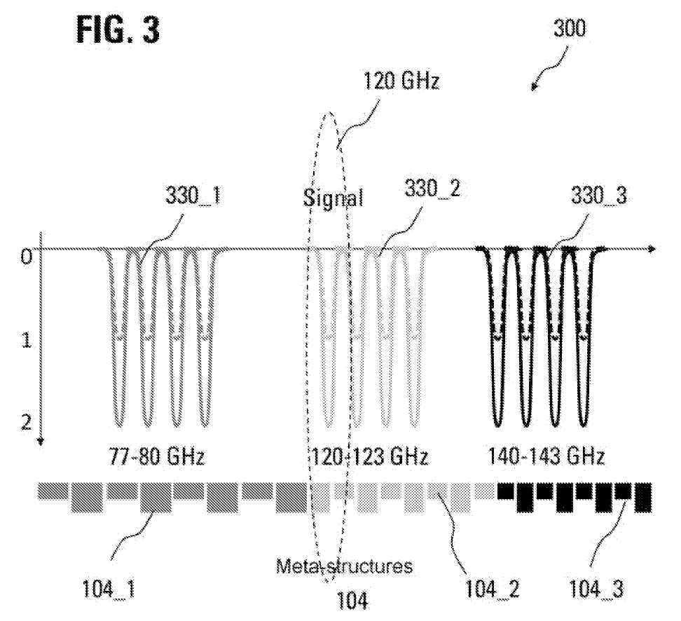

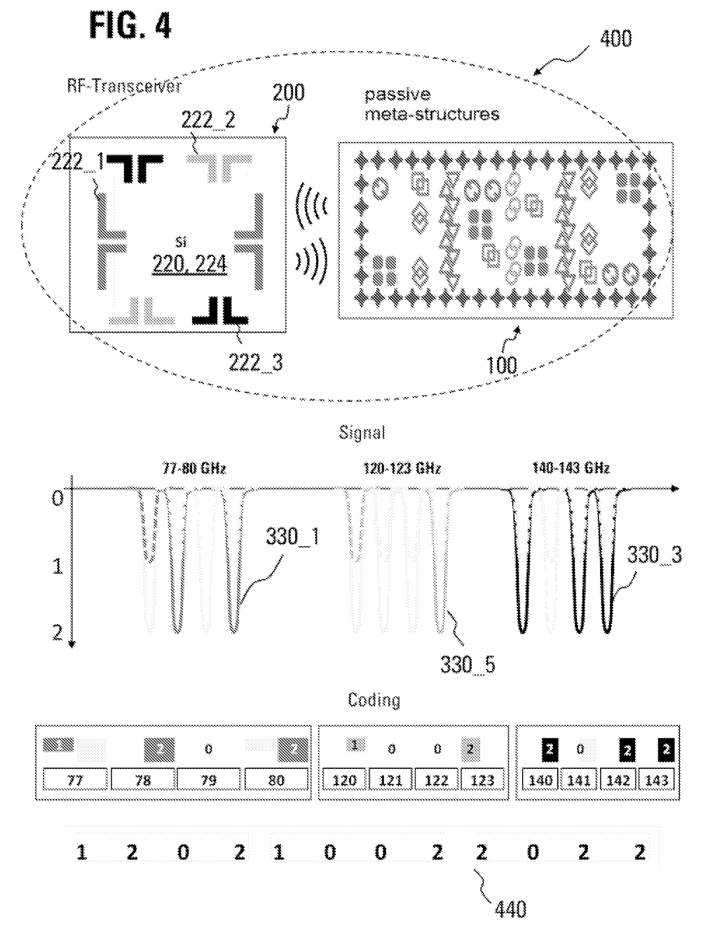

FIGS. 3 and 4 illustrate in detail by means of examples how the described function of the authentication device 200, in particular in cooperation with the authentication apparatus 100, should be understood.

FIG. 3 schematically illustrates coding possibilities in the authentication apparatus 100: Each of the frequency ranges named in FIG. 3 (77 to 80 GHz, 120 to 123 GHz and 140 to 143 GHz) has four (integer) frequencies, each of which is shown individually. Which of these are to be considered as belonging together in the different regions of the representation is illustrated by the mark for 120 GHz.

The lowermost line of symbols illustrates that the millimeter wave resonance structures 104 for each of the resonant frequencies can be designed in two ways for example: a small symbol illustrates weak resonance and a large symbol illustrates strong resonance (the possibility of the millimeter wave resonance structure 104 being missing for one of the resonant frequencies is omitted here; furthermore, depending on the technical feasibility, more than two resonance strength levels can be realized, for which in particular higher frequencies – e.g. within the frequency window mentioned above – may be suitable).

If a millimeter wave resonance structure 104 is designed for strong resonance, for example by virtue of a large number of the corresponding millimeter wave resonance structures 104 being formed in the authentication apparatus 100 (this is the case for example for the millimeter wave resonance structures 104_1, here for 78 GHz), this can lead to a high resonance strength, which is shown on the basis of the signal curves, whose maximum value is 2. For example, a code value of 2 can be assigned to this high resonance strength.

If a millimeter wave resonance structure 104 is designed for weak resonance, for example by virtue of a small number of the corresponding millimeter wave resonance structures 104 being formed in the authentication apparatus 100 (this is the case for example for the millimeter wave resonance structures 104_2 and 104_3, here for 122 Ghz and 143 GHz)), this can lead to a low resonance strength, which is shown on the basis of the signal curves, whose maximum value is 1. For example, a code value of 1 can be assigned to this low resonance strength.

Missing millimeter wave resonance structures 104 can lead to a signal strength of zero, which can be assigned, for example, a code value of 0.

The example which is shown in FIG. 3 and in which twelve different frequencies are emitted by the authentication device 200 in the direction of the authentication apparatus 100 and the respective resonance strengths are captured can make it possible to code 3¹² = 531441 different combinations/code words by assigning the code values 0, 1 or 2.

For example, if only four frequencies with three code values each are used instead, this allows 3⁴ = 81 different combinations, and eight frequencies with three code values each allow 3⁸ = 6561 different combinations.

Depending on the need for different possible combinations, a number of (resonant) frequencies used and/or a number of resonance strength levels can be varied.

FIG. 4 illustrates that millimeter waves are sent at twelve different frequencies in the direction of the authentication apparatus 100 by means of the authentication device 200. The authentication apparatus 100 and the authentication device may be tuned to each other and may together form an authentication system 400.

In the authentication device 200, only three of the twelve antennas 222 are shown for the different frequencies (each of the antennas 222_1, 222_2 and 222_3 is duplicated), and, in the authentication apparatus 100, only seven of the eight available millimeter wave resonance structures 104 are shown by way of example.

The center of FIG. 4 shows the resonance strengths received as a result of the sending of millimeter waves of the twelve different frequencies (simultaneously, in succession, or partially/partially) and captured in terms of their value. For example, a high resonance strength was determined for the frequencies 78, 80, 123, 140, 142 and 143 GHz.

This is respectively assigned a code value of 2 (see the second-lowest box).

A low resonance strength was determined for the frequencies 77 and 120 GHz.

This is respectively assigned a code value of 1 (see the second-lowest box).

There is no resonance at the frequencies 79, 121, 122 and 141 GHz (e.g. because the corresponding millimeter wave resonance structures 104 have been deliberately omitted in the authentication apparatus 100).

A code value of 0 is assigned to each of these frequencies (see the second-lowest box).

When a code word is formed using the assigned code values in ascending frequency order, this results in the code word 120210022022 (see lowest box in FIG. 4). Forming the code word using a different, for example predetermined, frequency order can result in a different code word.

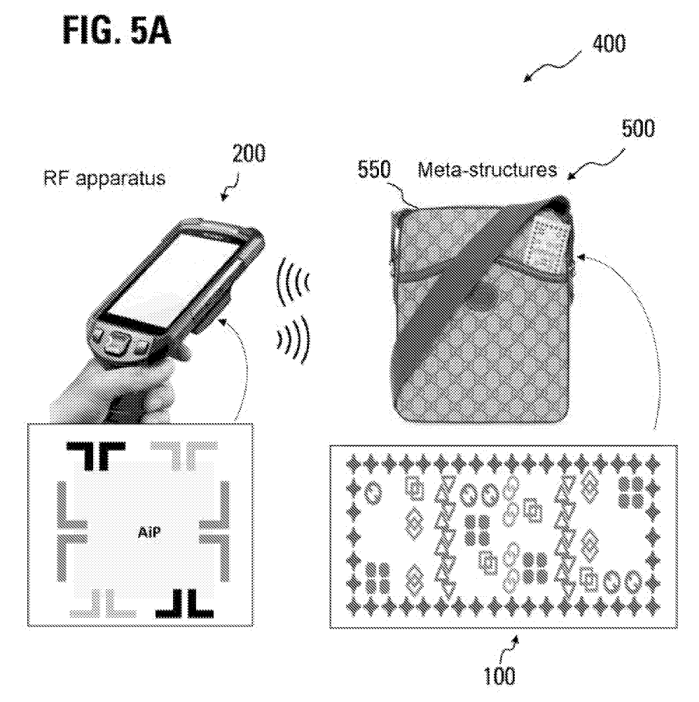

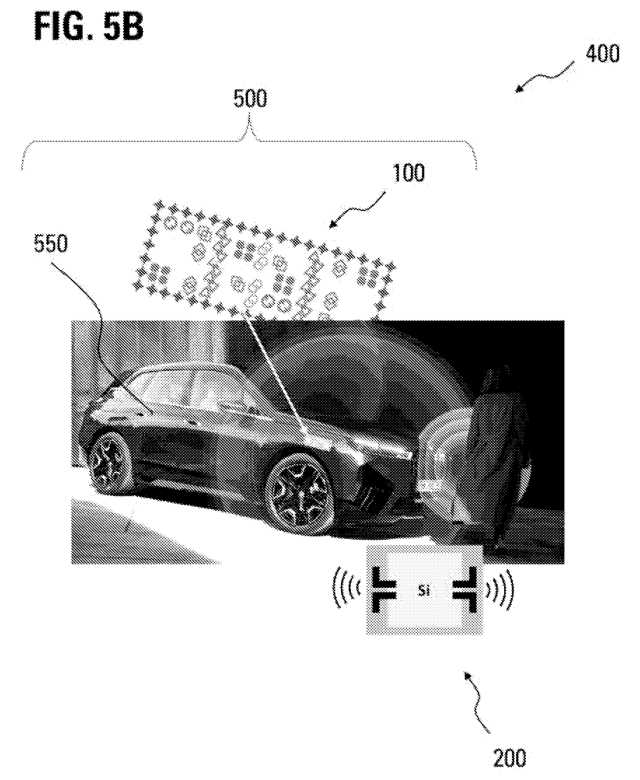

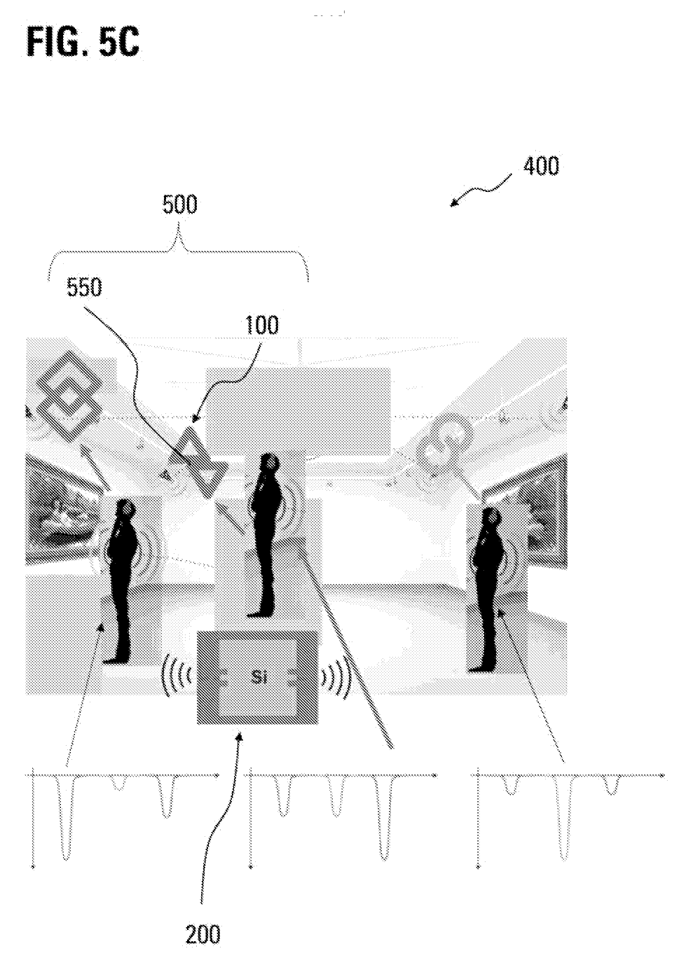

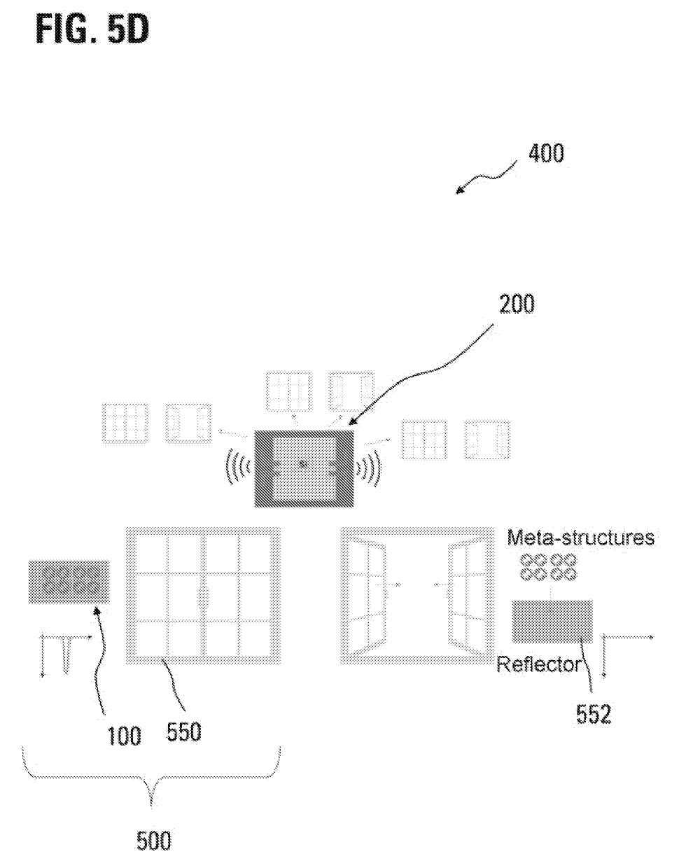

FIG. 5A shows an exemplary application for an authentication system 400 comprising an authentication device 200 and an authentication apparatus arrangement 500 comprising the authentication apparatus 100 and an authentication object 550 (shown here as a bag, for example). Even if the authentication apparatus arrangement 500 is shown as if the authentication apparatus 100 is merely inserted into an opening of the authentication object 550, it should be understood that the authentication apparatus 100 is typically attached to the authentication object 550 or is at least hidden so that it is not arbitrarily removable or interchangeable. Any object (or, if applicable, also a living being) that is sufficiently large for an attachment of the authentication apparatus 100, for example, a vehicle, a document, an electronic object, etc., may be possible as an authentication object.

FIG. 5B shows an exemplary application for an authentication system 400 for keyless access, for example for a vehicle as an authentication object 550.

Typically, in keyless access systems ("keyless access/entry"), a person is authenticated with respect to the locked region (in this case, the vehicle 550) using an authentication device 200.

In this case, the authentication apparatus 100 is attached to the vehicle 550, for example at an inaccessible location and/or hidden, for example, under the paint. The authentication apparatus 100 may be suitable for authenticating the vehicle 550 with respect to the authentication device 200.

This in turn can be used to transmit an access code, by means of the authentication device 200, to the vehicle 550, for example, only if it is ensured, by means of the authentication apparatus 100 scanned by means of the authentication device, that the authentication device 200 is actually located in the immediate vicinity of the authentication apparatus 100.

FIG. 5C shows an exemplary application for an authentication system 400 for orientation in space, for example in a museum with various art objects/images as authentication objects 550. If the orientation in a building is not intended to be coupled to certain furnishings, wall sections, doors, etc. can also serve as authentication objects 550.

A person wishing to orient himself in space by means of the authentication system 400 can scan the authentication apparatus 100 on the different images, for example by means of the authentication device 200, and can thus generate different code words depending on the image/position. In various exemplary embodiments, a software application, for example an app on a smartphone, may be configured to evaluate this code word and, for example, output associated information to the person, for example to indicate a position on a site plan and/or provide information relating to an associated artwork.

FIG. 5D shows an exemplary application for an authentication system 400 for monitoring opening states of access structures (e.g. doors/windows), i.e. as a "contactless contact sensor". Doors/windows, etc. can serve as authentication objects 550. However, in this exemplary embodiment, use can be made of the fact that the resonance strength can be strongly influenced by providing or removing a reflector 552.

For example, as illustrated in FIG. 5D, the authentication apparatus 100 can be provided in such a way that it is in front of reflector 552 only when the access structure (here: window sashes) is closed, thus generating strong resonance when irradiated. When the access structure is open, the authentication apparatus 100 and the reflector 552 can be separated from each other, such that no or only slight resonance occurs when irradiated.

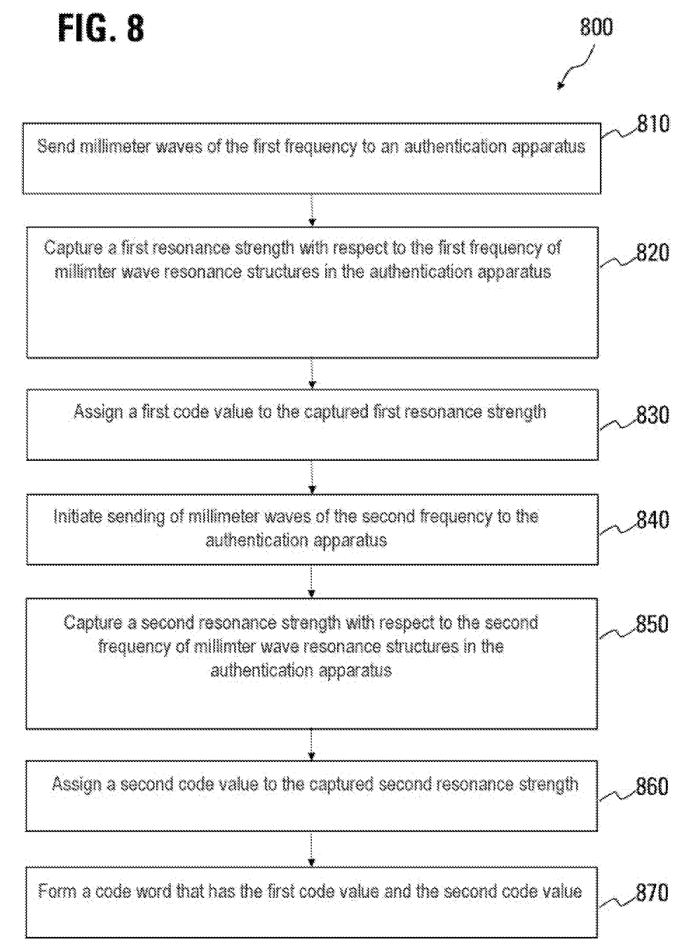

FIG. 8 shows a flowchart 800 of an authentication method according to various exemplary embodiments.

The authentication method comprises initiating sending of millimeter waves of the first frequency to an authentication apparatus (810), capturing a first resonance strength with respect to the first frequency of millimeter wave resonance structures in the authentication apparatus (820), assigning a first code value to the captured first resonance strength (830), initiating sending of millimeter waves of the second frequency to the authentication apparatus (840), capturing a second resonance strength with respect to the second frequency of millimeter wave resonance structures in the authentication apparatus (850), assigning a second code value to the captured second resonance strength (860), and forming a code word that has the first code value and the second code value (870).

Further advantageous configurations of the method emerge from the description of the apparatus, the device, the apparatus arrangement and the system, and vice versa.

There follows a summary of a few exemplary embodiments.

Exemplary embodiment 1 is an authentication apparatus. The authentication apparatus has a dielectric carrier and a plurality of millimeter wave resonance structures on or in the dielectric carrier, wherein at least one first millimeter wave resonance structure of the millimeter wave resonance structures has a first resonant frequency, which has a first resonance strength when irradiated at the first resonant frequency, and wherein at least one second millimeter wave resonance structure of the millimeter wave resonance structures has a second resonant frequency, which has a second resonance strength, which is equal to the first resonance strength or is different from it, when irradiated at the second resonant frequency.

Exemplary embodiment 2 is an authentication apparatus according to exemplary embodiment 1, wherein the at least one first of the millimeter wave resonance structures differs structurally from the at least one second of the millimeter wave resonance structures.

Exemplary embodiment 3 is an authentication apparatus according to exemplary embodiment 1 or 2, wherein the at least one first of the millimeter wave resonance structures has a different size and/or a different shape than the at least one second of the millimeter wave resonance structures.

Exemplary embodiment 4 is an authentication apparatus according to one of exemplary embodiments 1 to 3, wherein the at least one first of the millimeter wave resonance structures has no or substantially no resonance with millimeter waves of the second resonant frequency, and the at least one second of the millimeter wave resonance structures has no or substantially no resonance with millimeter waves of the first resonant frequency.

Exemplary embodiment 5 is an authentication apparatus according to one of exemplary embodiments 1 to 4, wherein the at least one first of the millimeter wave resonance structures has a plurality of first millimeter wave resonance structures, and/or the at least one second of the millimeter wave resonance structures has a plurality of second millimeter wave resonance structures.

Exemplary embodiment 6 is an authentication apparatus according to one of exemplary embodiments 1 to 5, wherein the plurality of millimeter wave resonance structures further comprise one or more further millimeter wave resonance structures having a further resonant frequency, which has/have a further resonance strength when irradiated at the further resonant frequency.

Exemplary embodiment 7 is an authentication apparatus according to one of exemplary embodiments 1 to 6, wherein the plurality of millimeter wave resonance structures comprise shapes from a group consisting of: a linear shape, a polygon shape, a circular or elliptical shape, a broken linear, polygon, circular or elliptical shape, and a superimposition of two or more of the above-mentioned shapes.

Exemplary embodiment 8 is an authentication apparatus according to one of exemplary embodiments 1 to 7, wherein the plurality of millimeter wave resonance structures have structure sizes in a range of multiples of λ/4, where λ is the wavelength of an associated operating frequency of a portion of an RF chip of an authentication device emitting the millimeter waves.

Exemplary embodiment 9 is an authentication apparatus according to one of exemplary embodiments 1 to 8, wherein the first resonant frequency and/or the second resonant frequency is/are in a range between 24 and 320 GHz.

Exemplary embodiment 10 is an authentication apparatus according to one of exemplary embodiments 1 to 9, further comprising: a metal layer attached to a main surface of the carrier facing away from an intended direction of incidence of the millimeter waves.

Exemplary embodiment 11 is an authentication apparatus arrangement. The authentication apparatus arrangement comprises an authentication object and an authentication apparatus according to one of exemplary embodiments 1 to 10, wherein the authentication apparatus is fixed to the authentication object.

Exemplary embodiment 12 is an authentication apparatus arrangement according to exemplary embodiment 11, further comprising: a top layer that covers the authentication apparatus.

Exemplary embodiment 13 is an authentication device. The authentication device has at least one transceiver which is configured to send and receive millimeter waves, wherein the at least one transceiver has a plurality of antennas, wherein at least one first antenna of the plurality of antennas is configured to send and receive millimeter waves of a first frequency, and wherein at least one second antenna of the plurality of antennas is configured to send and receive millimeter waves of a second frequency, and a processor which is configured to initiate sending of millimeter waves of the first frequency to an authentication apparatus, capture a first resonance strength with respect to the first frequency of millimeter wave resonance structures in the authentication apparatus, assign a first code value to the captured first resonance strength, cause sending of millimeter waves of the second frequency to the authentication apparatus, capture a second resonance strength with respect to the second frequency of millimeter wave resonance structures in the authentication apparatus, assign a second code value to the captured second resonance strength, form a code word that has the first code value and the second code value.

Exemplary embodiment 14 is an authentication device according to exemplary embodiment 13, wherein the at least one first antenna differs structurally from the at least one second antenna.

Exemplary embodiment 15 is an authentication device according to exemplary embodiment 13 or 14, wherein the at least one first antenna has a different size and/or a different shape than the at least one second antenna.

Exemplary embodiment 16 is an authentication device according to one of exemplary embodiments 13 to 15, wherein the at least one first antenna has a plurality of first antennas, and/or the at least one second antenna has a plurality of second antennas.

Exemplary embodiment 17 is an authentication device according to one of exemplary embodiments 13 to 16, wherein the plurality of antennas further comprise one or more further antennas configured to send and receive millimeter waves of a further frequency which is different from the first and the second frequency.

Exemplary embodiment 18 is an authentication device according to one of exemplary embodiments 13 to 17, wherein the plurality of millimeter wave resonance structures comprise shapes from a group consisting of: a linear shape, a polygon shape, a circular or elliptical shape, a broken linear, polygon, circular or elliptical shape, and a superimposition of two or more of the above-mentioned shapes.

Exemplary embodiment 19 is an authentication device according to one of exemplary embodiments 13 to 18, wherein the plurality of millimeter wave resonance structures have structure sizes in a range of multiples of λ/4, where λ is the wavelength of an associated operating frequency of a portion of an RF chip of an authentication device emitting the millimeter waves.

Exemplary embodiment 20 is an authentication device according to one of exemplary embodiments 13 to 19, wherein the first frequency and/or the second frequency is/are in a range between 24 and 320 GHz.

Exemplary embodiment 21 is an authentication device according to one of exemplary embodiments 13 to 20, wherein the processor is further configured to compare the code word with a reference code word.

Exemplary embodiment 22 is an authentication system. The authentication system comprises an authentication apparatus according to one of exemplary embodiments 1 to 10 or an authentication apparatus arrangement according to either of exemplary embodiments 11 and 12, and an authentication device according to one of exemplary embodiments 13 to 21, wherein the first frequency, for the emission of which the first antenna is configured, is equal to the first resonant frequency, and wherein the second frequency, for the emission of which the second antenna is configured, is equal to the second resonant frequency.

Exemplary embodiment 23 is an authentication system according to exemplary embodiment 22, wherein the authentication apparatus has millimeter wave resonance structures having shapes according to exemplary embodiment 7, and wherein the authentication device has antennas having shapes matched thereto according to exemplary embodiment 18.

Exemplary embodiment 24 is an authentication system according to exemplary embodiment 22 or 23, wherein the authentication apparatus has millimeter wave resonance structures having structure sizes according to exemplary embodiment 8, and wherein the authentication device has antennas having structure sizes matched thereto according to exemplary embodiment 19.

Exemplary embodiment 25 is an authentication system according to one of exemplary embodiments 22 to 24, wherein the authentication apparatus has millimeter wave resonance structures having structure sizes according to exemplary embodiment 8, and wherein the authentication device has antennas having structure sizes matched thereto according to exemplary embodiment 19.

Exemplary embodiment 26 is an authentication method. The authentication method comprises initiating sending of millimeter waves of the first frequency to an authentication apparatus, capturing a first resonance strength with respect to the first frequency of millimeter wave resonance structures in the authentication apparatus, assigning a first code value to the captured first resonance strength, initiating sending of millimeter waves of the second frequency to the authentication apparatus, capturing a second resonance strength with respect to the second frequency of millimeter wave resonance structures in the authentication apparatus, assigning a second code value to the captured second resonance strength, and forming a code word that has the first code value and the second code value.

Exemplary embodiment 27 is an authentication method according to exemplary embodiment 26, wherein the sending of millimeter waves is initiated in an authentication device according to one of exemplary embodiments 13 to 21.

Exemplary embodiment 28 is an authentication method according to exemplary embodiment 26 or 27, wherein the authentication apparatus is formed according to one of exemplary embodiments 1 to 10.

Exemplary embodiment 29 is an authentication method according to one of exemplary embodiments 26 to 28, which is carried out by means of an authentication system according to one of exemplary embodiments 22 to 25.

It should be pointed out that the description and the drawings only illustrate the principles of the proposed methods and apparatuses. A person skilled in the art will be capable of implementing different arrangements which, although they are not expressly described or shown here, embody the principles of the invention and are contained within the scope thereof. In addition, all examples and embodiments outlined in the present document are intended fundamentally and expressly for explanatory purposes only, in order to help the reader understand the principles of the proposed methods and apparatuses. In addition, all statements in this document that describe principles, aspects and embodiments of the invention and specific examples thereof are also intended to encompass their equivalents.

What is claimed is:

1. An authentication apparatus, comprising:
a dielectric carrier; and
a plurality of millimeter wave resonance structures coupled to the dielectric carrier;
wherein at least one first millimeter wave resonance structure of the millimeter wave resonance structures has a first resonant frequency, which has a first resonance strength when irradiated at the first resonant frequency; and
wherein at least one second millimeter wave resonance structure of the millimeter wave resonance structures has a second resonant frequency, which has a second resonance strength, which is equal to the first resonance strength or is different from the first resonant strength, when irradiated at the second resonant frequency.

2. The authentication apparatus of claim 1, wherein the at least one first of the millimeter wave resonance structures differs structurally from the at least one second of the millimeter wave resonance structures.

3. The authentication apparatus of claim 1, wherein the at least one first of the millimeter wave resonance structures has a different size and/or a different shape than the at least one second of the millimeter wave resonance structures.

4. The authentication apparatus of claim 1, wherein the at least one first of the millimeter wave resonance structures has no or substantially no resonance with millimeter waves of the second resonant frequency, and the at least one second of the millimeter wave resonance structures has no or substantially no resonance with millimeter waves of the first resonant frequency.

5. The authentication apparatus of claim 1, wherein the at least one first of the millimeter wave resonance structures has a plurality of first millimeter wave resonance structures, or the at least one second of the millimeter wave resonance structures has a plurality of second millimeter wave resonance structures.

6. The authentication apparatus of claim 1, wherein the plurality of millimeter wave resonance structures further comprise one or more further millimeter wave resonance structures having a further resonant frequency, which have a further resonance strength when irradiated at the further resonant frequency.

7. The authentication apparatus of claim 1, wherein the plurality of millimeter wave resonance structures have shapes from a group comprising:
a linear shape;
a polygon shape;
a circular or elliptical shape;
a broken linear, polygon, circular or elliptical shape; and
a superimposition of two or more shapes.

8. The authentication apparatus of claim 1, wherein the plurality of millimeter wave resonance structures have structure sizes in a range of multiples of λ/4, where λ is the wavelength of an associated operating frequency of a portion of an RF chip of an authentication device emitting the millimeter waves.

9. The authentication apparatus of claim 1, wherein the first resonant frequency and/or the second resonant frequency is/are in a range between 24-320 GHz.

10. The authentication apparatus of claim 1, further comprising:
a metal layer attached to a main surface of the dielectric carrier facing away from an intended direction of incidence of the millimeter waves.

11. An authentication device, comprising:
at least one transceiver configured to send and receive millimeter waves, wherein the at least one transceiver has a plurality of antennas;
wherein at least one first antenna of the plurality of antennas is configured to send and receive millimeter waves of a first frequency; and
wherein at least one second antenna of the plurality of antennas is configured to send and receive millimeter waves of a second frequency; and
a processor that is configured to:
cause millimeter waves of the first frequency to be sent to an authentication apparatus;
capture a first resonance strength with respect to the first frequency of a plurality of millimeter wave resonance structures in the authentication apparatus;
assign a first code value to the captured first resonance strength;
cause millimeter waves of the second frequency to be sent to the authentication apparatus;
capture a second resonance strength with respect to the second frequency of the plurality of millimeter wave resonance structures in the authentication apparatus;
assign a second code value to the captured second resonance strength; and
form a code word that has the first code value and the second code value.

12. The authentication device of claim 11, wherein the at least one first antenna differs structurally from the at least one second antenna.

13. The authentication device of claim 11,
wherein the at least one first antenna has a different size and/or a different shape than the at least one second antenna.

14. The authentication device of claim 11,
wherein the at least one first antenna has a plurality of first antennas, and/or the at least one second antenna has a plurality of second antennas.

15. The authentication device of claim 11,
wherein the plurality of antennas further comprise one or more further antennas configured to send and receive millimeter waves of a further frequency which is different from the first and the second frequency.

16. The authentication device of claim 11, wherein the plurality of millimeter wave resonance structures have structure sizes in a range of multiples of λ/4, where λ is the wavelength of an associated operating frequency of a portion of an RF chip of an authentication device emitting the millimeter waves.

17. The authentication device of claim 11, wherein the processor is further configured to compare the code word with a reference code word.

18. An authentication system, comprising:
an authentication apparatus, comprising
a dielectric carrier; and
plurality of millimeter wave resonance structures coupled to the dielectric carrier;
wherein at least one first millimeter wave resonance structure of the millimeter wave resonance structures has a first resonant frequency, which has a first resonance strength when irradiated at the first resonant frequency; and
wherein at least one second millimeter wave resonance structure of the millimeter wave resonance structures has a second resonant frequency, which has a second resonance strength, which is equal to the first resonance strength or is different from the first resonant strength, when irradiated at the second resonant frequency; and
an authentication device, comprising:
at least one transceiver configured to send and receive millimeter waves, wherein the at least one transceiver has a plurality of antennas;
wherein at least one first antenna of the plurality of antennas is configured to send and receive millimeter waves of the first resonant frequency; and
wherein at least one second antenna of the plurality of antennas is configured to send and receive millimeter waves of the second resonant frequency; and
a processor that is configured to:
cause millimeter waves of the first resonant frequency to be sent to the authentication apparatus;
capture a first resonance strength with respect to the first frequency of millimeter wave resonance structures in the authentication apparatus;
assign a first code value to the captured first resonance strength;
cause millimeter waves of the second resonant frequency to be sent to the authentication apparatus;
capture a second resonance strength with respect to the second frequency of millimeter wave resonance structures in the authentication apparatus;
assign a second code value to the captured second resonance strength; and
form a code word that has the first code value and the second code value.

19. The authentication system of claim 17, wherein the processor is further configured to compare the code word with a reference code word.

20. The authentication system of claim 17, wherein the at least one first of the millimeter wave resonance structures has no or substantially no resonance with millimeter waves of the second resonant frequency, and the at least one second of the millimeter wave resonance structures has no or substantially no resonance with millimeter waves of the first resonant frequency.
